(19) United States
(12) Patent Application Publication
(10) Pub. No.: US 2004/0244699 A1
(43) Pub. Date: Dec. 9, 2004

(54) Method for milking an animal, in particular a cow

(76) Inventors: Anne Schulze Schwering, Munster (DE); Peter Kaever, Oelde (DE); Andreas Springer, Beckum (DE)

Correspondence Address: Smith & Amundsen, 440 Science Drive, Suite 302, Madison, WI, 53711, US

(21) Appl. No.: 10/481,614

(22) PCT Filed: Jun. 20, 2002
(86) PCT No.: PCT/EP02/06864

(30) Foreign Application Priority Data
Jun. 21, 2001 (DE) 10129475.1

(51) Int. Cl. A01J 5/04

(52) U.S. Cl. 119/14.5

(57) ABSTRACT

The invention relates to a method for milking an animal, in particular a cow, according to which a characteristic (KG) of the milking operation is first determined. Said characteristic (KG) is composed of at least one of the following variables: the actual value (IW) of the milk flow (MF), the temporal modification of said flow and/or the accumulated quantity of milk (MM). A threshold value (SK) for determining the end of a milking operation is determined in accordance with the characteristic(s) (KG). The end of the milking operation is predicted using the characteristic (KG) and the threshold value (SK). An evaluation variable (BG) of the milking operation is determined during said milking operation, whereby this/these evaluation variable(s) (BG) take(s) into account at least one of the following variables: the actual value (IW) of the milk flow (MF), the temporal modification of said flow and/or the accumulated quantity of milk (MM). The end of the milking operation is initiated, when the evaluation variable (BG) essentially corresponds to the threshold value (SK), or falls below the latter.

The object of the present invention refers to a method for milking an animal, in particular a cow.

During traditional manual milking, which is a pressure milking method, almost the entire amount of milk present in the udder can be milked. In the machine suctional milking method there is a problem, first of all some quarters are milked too long although no more milk flow is present, and, on the other hand, in individual quarters, the milking process is ended too soon and therefore residual milk remains in the udder. The reason for this is first of all due to the process but also due to anatomical reasons. There is a possibility that when the udder is kinked or rotated due to unfavorable shape of the udder and also due to the fact that the milking tool does not exactly fit the teats, this has a negative influence on the suctional milking process, so that the milk-conducting channel of the teats becomes closed too soon. As a result of this, above all in the end phases of the milking process, namely in the post-milking phase and the milking-out phase, the milk yield is reduced in comparison to manual milking. Also, the quality of the milk milked can be influenced adversely, since, especially in the final phases of the milking, milk components are obtained that have an especially high fat content.

During the milking process, the tissues of the udder between the gland and the teat cisterns draw increasingly together under the action of the milking pressure. Due to the increased vacuum inside the teat rubber of a milk cup and due to the declining milk flow toward the end of the milking process, fluid can accumulate in the area of the Fürstenberg venous ring. This accumulation of fluid may lead to the development of edema, as a result of which, usually, permanent closure of the milk-conducting channels in the teats may occur, which can be opened again only after application of a higher tensional force. This effect is further accentuated by the acceleration pressure and flow pressure of the milk column. Generally, this leads to the fact that the milk cup begins to creep up on the teat and the milking out and post-milking phase occur too early, as a result of which the milking process ends sooner than desired.

In order to avoid this effect, it is known that a down-directed force can be applied to the collecting piece of the milking tool, as a result of which the udder tissue will be tensioned and the closure can occur later. After a predetermined period of time, the post-milking process and thus the entire milking process is ended.

In the milking processes known in the art, a problem is that when the “milking-out” is too strong, adverse effects on the condition of the teats may arise. Especially, there is a danger of hyperkeratosis.

It is known from DE3609275A1 that the change of the quantity of milk and/or of the milk flow as a function of time has characteristic properties within the individual pulse cycles during machine removal of milk, which can be utilized for evaluation of the effectiveness of the instantaneous setting of the milking parameters on the release of milk from the teats. By evaluation of a milk flow profile, it can be determined if a given milking parameter is set optimally. Based on the course of the milk-flow profile, it can also be recognized when the teat has been milked to the extent that continuation of the milking process would lead to blind milking. In this case, for example with a control, a command can be issued for ending the milking and optionally for removing the milking tool.

A method is known from EP 0534565B1 for automatic milking of animals, for example cows, using a device with a milking installation which has a computer and a milking robot with teat cups which are to be connected automatically to the teats of an animal to be milked. Signals are produced by a flow sensor, which indicate the beginning and the end of the milk flow from at least one teat. If the computer determines that the dead time, which elapses between the time for which a vacuum-responding sensor indicated sufficient vacuum in a teat cup attached to the corresponding teat, and the time for which the flow meter determined the beginning of milk flow from this teat, goes beyond a predetermined point in time, then the teat cup is automatically put out of operation.

Another method has become known from DE2844562B1 for automatic milking with machine removal of the milk. For this purpose, continuous milk-flow measurement is performed. The measurement detects changes of milk flow per unit time. Immediately after a decrease of milk flow of more than 1 kg per minute for a duration of 5 to 10 seconds, it is determined that the milk flow is low, so that an additional signal can be produced which triggers the removal of the milking tool.

The goal of the present invention is a method for milking an animal in which the end of the milking process is determined, so that first of all the teats of an animal to be milked are protected and on the other hand relatively complete milking can be provided.

According to the invention the tasks are solved by the characteristics of claim 1. Advantageous further developments of the method are the objects of the subclaims.

According to the method of the invention for milking an animal, particularly a cow, it is proposed that first a characteristic of the milking process be determined. This characteristic is composed at least of one of the following variables: the actual value of the milk flow, the time change of this and/or the accumulated quantity of milk. Depending on the at least one characteristic, a threshold value is determined for establishing the end of a milking process. This end of the milking process is predicted with the aid of the characteristic and the threshold value. During the milking process, an evaluation variable of the milking process is determined and this at least one evaluation variable takes into consideration at least one of the following quantities: the actual value of the milk flow, its change with time and/or the accumulated quantity of milk. The end of the milking process is initiated when the evaluation variable corresponds essentially to the threshold value or sinks below it.

As a result of this conduction of the process according to the invention, on the one hand the danger can be avoided that very incomplete emptying of the udder will occur and, on the other hand, the danger of blind milking and thus the hyperkeratosis caused by it can also be avoided.

This method according to the invention utilizes the finding that the milk flow curve has a typical course, so that, depending on the milk flow, the point of time at which the end of the milking process should be initiated can be predicted with high probability at the beginning of the milking process. With this measure it is not absolutely necessary to determine the milk flow during the entire milking process continuously with high resolution. Instead, for example, due to the improved filtration, using the characteristic or evaluation variable, an adjustment to the course of the quantity of milk in the milking process can be performed. In this way, adaptation of the scanning rate is possible so that the amount of data and thus the load on the control can be reduced to a minimum. As long as it seems expedient for dairy cattle operation and herd management, either a continuous measurement of the milk flow or transfer of this in very compact characteristics values can be done and both possibilities of measurement of the milk flow yield data which can be used for the regulation and/or control as well as for obtaining further information.

It was found that the utilization of such characteristics and evaluation variables provides advantages when the determination is done from a linear combination of milk flow, accumulated quantity of milk and temporal change of the milk flow. Especially, it is proposed that the evaluation variable be determined at time t(BGₜ) corresponding to the equation

BGₜ=K1*MF+K2*d(MF)/dt+K4*(MM−1/K5*∫^{t}MFdτ)

Where MF is the milk flow and MM gives the expected quantity of milk, for example, the expected total quantity of milk. The expected quantity of milk or the expected total quantity of milk can be determined with the aid of several milking processes.

Here, K1, K4 are proportionality factors and K2 and K5 are time constants which permit evaluation of the various dynamic aspects advantageously during the parameterization of the process.

The characteristic value KG can be determined in the same way as the evaluation variable BG, since both the characteristic value KG as well as the evaluation variable BG are composed of at least one of the following quantities: the actual value of the milk flow, its change as a function of time and/or the accumulated quantity of milk. However, this is not absolutely necessary. Preferably, the characteristic value at time t(KGₜ) is determined in the same way as the evaluation variable.

According to another advantageous embodiment of the method, it is proposed that the threshold value be determined from the evaluation variable and the characteristic values at the time of the threshold value in such a way that a larger evaluation variable/characteristic value gives a higher threshold value. The evaluation variable/characteristic value and the threshold value are coupled through a calculation using a formula in which all quantities are used as being comparable in the method. The comparison between evaluation variable and threshold value can especially be carried out in such a way that during the triggering of the removal signal in case of a larger evaluation variable, the threshold value is also set higher.

For example, regarding the threshold value, it is proposed that this be determined according to the following equation:

SK=K4+K5*KG(t₀)+K6*KG(t₀+T)

Here, K4 corresponds to an offset of the evaluation variable, while K5 and K6 are dimensionless quantities.

Analogously to this, in the determination of the threshold value, one or several of the characteristic values KGₚ can be used in the same way in case these are calculated separately for different phases of the milking process.

In order to increase the certainty with regard to parameterization when determining the threshold values for the end of a milking process as well as for obtaining reproducible results, according to an advantageous embodiment of the method, it is proposed that a target value which defines the beginning of a milking process be determined. Especially, it is proposed that a time span be specified between the beginning of the milking process, which is determined by reaching the target value, and a time point, which is the threshold value for ending the milking process, be determined. A further development of the method is preferred in which at the time of beginning the milking, the evaluation variable corresponds essentially to the target value.

Preferably the time span between the beginning of milking and the time at which the characteristic value is determined is shorter than two minutes. A process conduct is preferred in which this time span is essentially one minute. After the elapse of this time span it was determined that, for example, a defined milk flow is present which forms the basis for the predicted end of the milking process. Other or additional criteria can also be used for the determination of the end of milking, especially the temporal change of the milk flow and/or the accumulated quantity of milk and/or the expected amount of milk.

Preferred is a target value which defines the beginning of a milking process, and the time span (T) between the beginning of the milking (t₀) and the time point (t_{SK}), at which the threshold value (SK) for the actual milking process is determined. The time point (t₀) is reached when the characteristic value essentially corresponds to the target value (S). Especially, an especially simple embodiment of the invention is proposed in which this characteristic value first represents the milk flow and reaches the target value of at least 50 g/min, preferably 75 g/min and especially 100 g/min. According to an even more advantageous embodiment of the method, it is proposed that the minimum milk flow of a target value be greater than 50 g/min, preferably greater than 150 g/min, especially greater than 200 g/min.

Preferably, the actual milking process begins when the target value is reached.

According to an even further advantageous embodiment of the method, it is proposed that the time point to can be defined by a time span according to a batching process. The end of the milking process is preferably defined by at least one threshold value.

In another advantageous embodiment of the method, the condition is utilized that the target value can be compared directly with the evaluation variable/characteristic value. Therefore, the target value can also be understood as being obtainable according to the above formula from the milk flow. The individual character of the above formula for each milking process makes it possible to determine the target value for the individual animal, and this value then can be provided before each milking process. Thus, the time point (t₀) can be determined by comparison of the target value with the characteristic value.

According to still another advantageous embodiment of the method, it is proposed that the time point (t₀) is predetermined and the calculation of the characteristic value KG(t₀) is established temporally. Especially, it is proposed that the determined time be dependent on the phase of the milking process. Especially it is proposed that the determination of the characteristic values be carried out at the end of the equipping process, after the removal of the cistern milk to the end of the stimulation, or after exceeding a threshold for the minimum milk flow, or at the end of the main milking phase. This leads to phase-specific characteristic values (KGₚ) which can also be utilized in the calculation of the threshold value.

Furthermore, in order to improve the prediction at the end of the milking process, it is proposed that the milking process be subdivided into at least two phases. These phases can be, for example, the phase in which the removal of the cistern milk occurs, the beginning of the milking, a main milking time, and an end of milking. Always a characteristic value and a corresponding threshold value is determined for these milking phases. The number and the duration of the phases can be chosen freely. It is advantageous when the division of the milking process into the individual phases is oriented according to the characteristic progress of the milk flow as a function of time, so that for the course of the milking process characteristic quantities—phase characteristic values, phase evaluation variables, phase thresholds—can be determined which provide a relevant prediction about the milking process.

A threshold value for the determination of the end of the milking process is derived from the phase characteristic values, the phase threshold values and/or from the phase evaluation variables. Since the duration of the individual phases represents additional information, in a further preferred embodiment, they can be utilized in the calculation of the threshold value for the end of a phase, and especially for the calculation of the threshold at removal.

It is also possible to combine several individual phases. Through this advantageous further development of the method, increased reliability is achieved with regard to the determination of the end of the milking process.

The threshold value in the first phase is predetermined from the target value and is derived according to the above considerations from settings or from individual animal parameters, which are provided at the beginning of a milking process.

The phase is considered to be ended when the phase threshold value essentially corresponds to the corresponding phase characteristic value or drops below it and optionally a phase-dependent time shift is expired. It is not absolutely necessary that such a time shift be taken into consideration in the determination of the phase evaluation variables. A threshold value for determination of the end of the milking process is formed from the evaluation variables at the end of the milking phases and/or from the times of the phases of the milking process. The determination of the evaluation variable can be done preferably continuously so that the end of the milking process is then initiated when the corresponding evaluation variable essentially corresponds to the threshold value or drops below it.

The determination of the evaluation variable includes especially knowledge about the milk flow, the time change of the milk flow and the expected quantity of milk. The following equation is proposed for the determination of the phase characteristic value of KGₜ at time t:

KGₜ=K1*MF+K2*d(MF)/dt+K4*(MMₚ−1/K5*∫^{t}MFdτ)

In this equation, the milk flow and MMp give the amount of milk expected in the individual phases. K1 and K4 are proportionality factors, and K2 and K5 are time constants.

To improve the quality of the measurement technology, the quantity K2*d(MF)/dt and alternatively also the difference quotient K2*(MFₜ−MF_{beginning of milking})/(t−t_{beginning of milking}).

The determination of the phase characteristic value is set at the beginning of each phase shifted in time, depending on the threshold values to the initial value at the beginning of milking or to the values at the beginning of the completed phase displaced in time or as a function of the threshold values. When doing this, especially the lower limit of the integral is determined again or the MFₚ or tₚ is set anew in the difference quotient: for example, with regard to the beginning of the milking process, this means the use of MF_{beginning of milking} and t_{beginning of milking}.

The parameters in the equation for the determination of the phase evaluation variable can be set differently in all phases in order to take into consideration the different dynamics of the course of the milking process. This also applies to the quantity of milk extracted which can be different in the individual phases. Especially, the determination of the phase evaluation variable at the end of the milking process to the point when the milking tool is taken off with a separate set of parameters makes sense because here a function-determining part of the function is triggered.

The development of a method in which the threshold value for determining the end of the milking process is determined from the phase characteristic values taking into consideration the duration of the individual phases is preferred. Then the threshold value can be determined by a linear combination of the phase characteristic values KGₜⱼ to the end of phases j in combination with the evaluation variables. Especially, it is proposed that the threshold value for establishing the end of the milking process be determined by the equation

SKₑ=K+ΣᵢKᵢ*BGₜᵢ+ΣKⱼ*KGₜⱼ

Here Kⱼ are phase-dependent factors, BGₜᵢ are evaluation variables at the times t₀ and t₀+T and KGtₜⱼ are phase characteristic values.

In this special consideration of milking in a teat-protecting way it is proposed that the characteristic value KG be determined at the beginning of the milking process, the evaluation variable BG, the threshold values SK and/or the target values be determined at least individually for each quarter. Therefore, the ending of the milking process occurs individually for each quarter. Udders with irregular shape or with damaged quarters are taken into consideration this way.

According to yet another advantageous further development of the method, it is proposed to store the evaluation variables and characteristic quantities of sequential milking processes of the same cow in order to obtain good settings a priori.

Other details and advantages of the method according to the invention are explained with the aid of the diagrams shown in the drawing.

The following are shown:

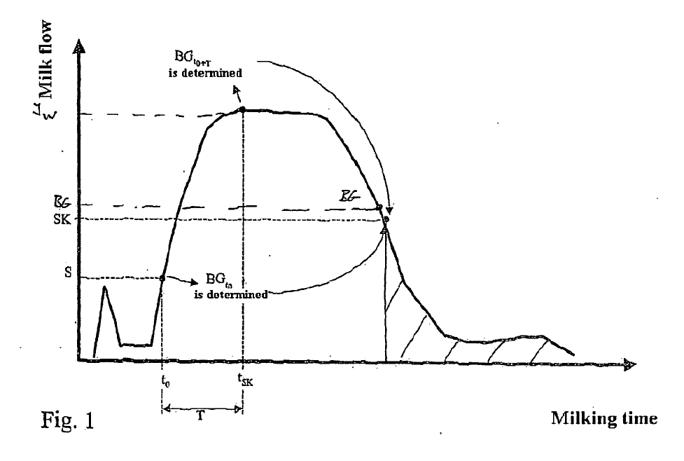

FIG. 1 is a schematic illustration of a first milk flow diagram

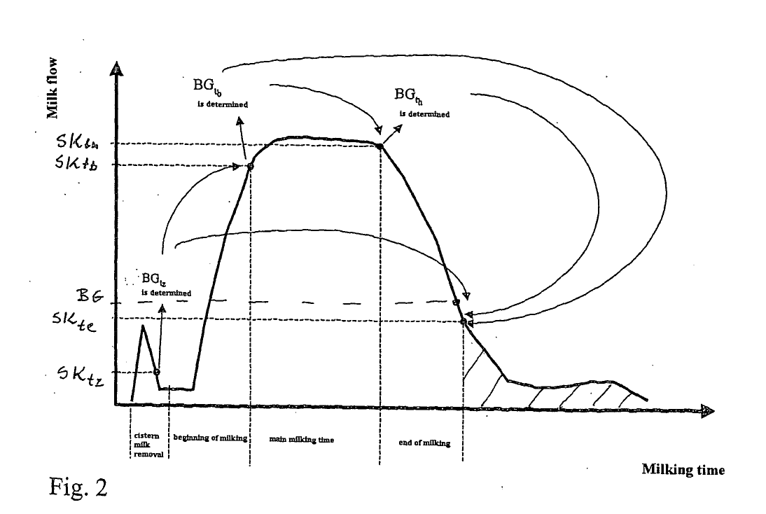

FIG. 2 is second milk flow diagram

The diagram in FIG. 1 shows schematically the course of the milk flow as a function of time. A target value S is prescribed. The value defines the beginning of a milking process. The beginning of the milking process is shown on the milking-time axis with to. At the beginning of the milking process, that is, at time to, an evaluation variable BGt₀ and a characteristic value KGt₀ are determined.

The determination of a threshold value SK as well as optionally a prediction of the duration of the milking process is carried out as a function of the characteristic value KGt₀. This threshold value SK is provided for establishing the end of the milking process. The threshold value SK has the function of the characteristic value KG.

After a predetermined time T, at time t_{SK}, the actual value I_{w} of the milk flow is measured. Furthermore, the temporal change of the actual milk flow as well as the accumulated quantity of milk are determined. These data form an additional foundation for the determination of a characteristic value KG as well as of an evaluation variable BG_{t0+T}.

As a function of the newly-determined characteristic value KG, a determination of the threshold value SK_{t0+T} is performed. This threshold value also serves for the determination for the end of the milking process.

The following applies to the determination of the threshold value at time t₀+T in a simple form:

SK=K4+K5*BG(t₀)+K6*BG(t₀+T)

During the milking process an evaluation variable BG is determined which is obtained from the actual value of the milk flow, its temporal change and the accumulated quantity of milk. The evaluation variable is preferably determined according to the equation

BGₜ=K1*MF+K2*d(MF)/dt+K4*(MM−1/K5*∫^{t}MFdτ)

where MF stands for the milk flow and MM for the expected quantity of milk and the constants are as follows:

K1, K4 are proportionality factors

K2 and K5 are time constants.

The determination of the evaluation variables KGₜ is carried out analogously.

The end of the milking process is initiated when the evaluation variable BG corresponds essentially to the threshold value SK or drops below it.

Depending on the relevant quantities at the beginning of the milking process, the threshold value SK can assume a higher or lower value so that the evaluation variable BG which is necessary for removal changes correspondingly.

FIG. 2 shows a second diagram which is a schematic representation of the course of a milk flow. The milk flow can be divided into different phases. In the practical example shown, the milk flow is divided into a phase in which the cistern milk is removed, the beginning phase of milking, the main milking phase, and the end phase of milking. The evaluation variables at the end of these milking phases are designated by KG_{tz} for the removal of the cistern milk, KG_{tb} for the beginning of milking, KGₜₕ for the main milking time, and KGₜₑ for the end of milking. The threshold values SK_{tb} for the determination of the end of the various phases are noted analogously.

The determination of the end of a milking phase is done by considering the characteristic value KGₜ and its comparison with a threshold value SK assigned to this phase. The phase is considered to be ended when the threshold value of the corresponding phase corresponds essentially to the characteristic value or drops below it, and, additionally, a dependent time delay has elapsed. This time delay can also vanish.

A threshold value SKₑ is formed from the characteristic values at the milking phases KG_{tz} to determine the end of the milking process. The end of the milking process is then initiated when the evaluation quantity BG corresponds only to the threshold value SK or drops below it.

The milking process as such can be subdivided into additional phases. The individual phases can also be combined.

Udder quarters which reach a higher characteristic value usually show a steep drop in the milk flow curve towards the end of the milking process. Therefore, by ending the milking process at a higher threshold value, the condition of the teats is protected and it is ensured that the amount of milk remaining in the udder is small.

The area under the curve after the ending of the milking process shown in FIGS. 1 and 2 corresponds to the amount of milk which was not milked. This remaining residual milk is sufficiently small so that this can be taken into consideration. The course of the milk flow can be determined continuously or discontinuously.

Udder quarters which reach a low characteristic value usually show a low course of the milk flow curve over the entire period of milking. Here the ending of the milking process according to the method occurs at a low threshold value so that it is ensured that the milking process is not ended too soon and the udder quarter can be milked until it is quite empty. The target values are preferably established individually for each udder quarter and the target values can be different for the individual udder quarters.

1-17. (cancelled)

18. A method for milking an animal, comprising:
determining a characteristic value for a milking process based on a milk flow quantity;
assigning a threshold value to the characteristic value for the milking process;
calculating an evaluation variable during the milking process based on the milk flow quantity; and
terminating the milking process when the evaluation variable drops below the threshold value.

19. The method of claim 18 wherein the milk flow quantity is a quantity selected from the group consisting of: actual milk flow quantity, temporal change in milk flow, accumulated milk quantity and combinations thereof.

20. The method of claim 18 wherein the evaluation variable (BG) is calculated from a linear combination of actual milk flow quantity, accumulated milk quantity, and a temporal change value of the actual milk flow quantity.

21. The method of claim 18 wherein the evaluation variable is calculated using the equation
BGₜ=K1*MF+K2*d(MF)/dt+K4*(MM−1/K5*∫^{t}MFdτ)
wherein BGₜ is the evaluation variable, MF equals actual milk flow quantity, MM equals an expected milk quantity, K1 is a proportionality factor, K4 is a second proportionality factor, K2 is a time constant and K5 is a second time constant.

22. The method of claim 18, further comprising:
measuring the evaluation variable at a particular time in the milking process and;
increasing the threshold value proportionately to the evaluation variable.

23. The method of claim 18 where the threshold value is determined using the equation
SK=K4+K5*BG(t₀)+K6*BG(t₀+T)
wherein SK is the threshold value, BG(t₀) is the evaluation variable at a first moment, BG(t₀+T) is the evaluation variable at a second moment, K4 is an offset of the evaluation variable, K5 is a first constant and K6 is a second constant.

24. The method of claim 23 further comprising:
predetermining the evaluation variable at the end of a milking phase.

25. The method of claim 24 wherein the milking phase is selected from the group consisting of: an equipment application phase, a stimulation phase and a cistern milk removal phase.

26. The method of claim 23 further comprising:
determining the evaluation variable once milk flow quantity has exceeded a minimum milk flow value.

27. The method of claim 18, further comprising:
predetermining a target value for the milk flow quantity, the target value marking a beginning of the milking process.

28. The method of claim 27, further comprising:
measuring a time span from the beginning of the milking process to a threshold time when the threshold value is approached.

29. The method of claim 28 wherein the evaluation variable corresponds to the target value.

30. The method of claim 27 wherein the time span is less than 2 minutes.

31. The method of claim 21 wherein the target value is defined using a minimum milk flow quantity.

32. The method of claim 31 wherein the minimum milk flow quantity is between 50 grams per minute and 100 grams per minute.

33. The method of claim 31 wherein the minimum milk flow quantity is between 75 grams per minute and 100 grams per minute.

34. Method for milking an animal, comprising:
determining a first characteristic value for a first milking phase based on a milk flow quantity;
assigning a first threshold value to the first characteristic value;
determining a second characteristic value for a second milking phase based on the milk flow quantity;
assigning a second threshold value to the second characteristic value;
calculating a total threshold value based on the first and second threshold values;
calculating a first phase evaluation variable based on expected milk flow quantities during the first phase; and
calculating a second phase evaluation variable based on expected milk flow quantities during the second phase.

35. The method of claim 34 in which each of the phase evaluation variables is determined using the equation
BGₜ=K1*MF+K2*d(MF)/dt+K4*(MMₚ−1/K5*∫^{t}MFdτ)
where MF is the milk flow quantity, MMₚ is expected milk flow quantities during each of the phases, K1 is a first proportionality factor, K4 is a second proportionality factor, K2 is a first time constant and K5 is a second time constant.

36. The method of claim 34 further comprising:
determining a total threshold value by linear combination of the first phase evaluation variable and the second phase evaluation variable.

37. The method of claim 36 in which the total threshold value is determined using the equation
SKₑ=K+ΣᵢKᵢ*BGₜᵢ+ΣKⱼ*KGₜⱼ
wherein SKₑ is the total threshold value, Kᵢ is a first phase dependent factor, Kⱼ is a second phase-dependent factor, BGₜᵢ is based on the first evaluation variable and the second evaluation variable and KGₜⱼ is based on the first characteristic value and the second characteristic value.
